(19) United States
(12) Patent Application Publication
(10) Pub. No.: US 2026/0034556 A1
(43) Pub. Date: Feb. 5, 2026

(54) SLIDING RISER

(71) Applicant: Kohler Mira Limited, Cheltenham, Gloucestershire (GB)

(72) Inventors: David A. Pixton, Cheltenham (GB); Toby Risbey, Cheltenham (GB); Sam Trower, Cheltenham (GB)

(21) Appl. No.: 19/285,843

(22) Filed: Jul. 30, 2025

Related U.S. Application Data
(60) Provisional application No. 63/679,493, filed on Aug. 5, 2024.

(51) Int. Cl. B05B 15/628; E03C 1/04

(52) U.S. Cl. CPC B05B 15/628; E03C 1/0408

(57) ABSTRACT

A sliding riser system is provided herein which may include at least one moving riser bar attached at a first end to a showerhead, at least one fixed inlet waterway connected to a fluid line, and a balance spring mechanism which may include a balance spring attached at a free end to the at least one moving riser bar. The fluid line may provide water to the sliding riser system, and thereby, to the showerhead for use. A portion of the moving riser bar may be housed within the fixed inlet waterway, or a portion of the fixed inlet waterway may be housed within the moving riser bar. Such housing may cause fluid flowing in the fixed inlet waterway to transfer and flow into the moving riser bar.

### CROSS-REFERENCE TO RELATED APPLICATIONS

The present application claims priority to U.S. Provisional Patent Application No. 63/679,493, filed Aug. 5, 2024, entitled, “SLIDING RISER,” the entire contents of which is hereby incorporated by reference.

### BACKGROUND

Adjustable riser bars are useful in various contexts, including in shower systems. These riser bars may be used to adjust a height of a showerhead or switch between an overhead showerhead and a handheld showerhead, which may be particularly useful for households with people and/or animals of varying heights and mobility.

### BRIEF DESCRIPTION OF DRAWINGS

FIG. 1 is a perspective view of an example sliding riser shower system.

FIG. 2 is a first cross-sectional view of an example sliding riser shower system.

FIG. 3 is second cross-sectional view of an example sliding riser shower system.

FIG. 4 is a third cross-sectional view of an example sliding riser shower system.

FIG. 5 is a front view of an example sliding riser shower system.

FIG. 6 is a first cross-sectional view of an example sliding riser shower system.

FIG. 7 is a second cross-sectional view of an example sliding riser shower system.

FIG. 8 is a third cross-sectional view of an example sliding riser shower system.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

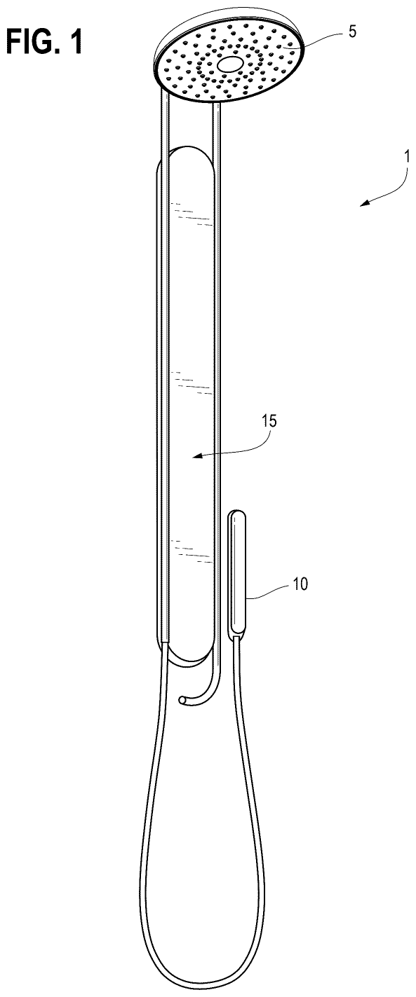

Turning first to FIG. 1, a sliding riser system 1 may include a showerhead 5 and/or a handheld showerhead 10 (the showerhead 5 and handheld showerhead 10 may be any desirable or suitable showerhead) connected to a sliding riser 15. The sliding riser 15 may be used to adjust the showerhead 5 to a different height, which may accommodate different heights of users. Further, the sliding riser 15 may be used to adjust the showerhead 5 even when fluid (e.g., water) is flowing through the sliding riser system 1 and out of the showerhead 5. The sliding riser system 1 may adjust in height in large adjustment ranges and may be substantially pressure balanced such that the sliding riser system 1 may be adjusted in height and maintain a desirable pressure when adjusted. The sliding riser system 1 may be adjusted even when water is flowing through the showerhead 5 and the showerhead 5 is in use. Further, the sliding riser system 1 may incorporate a substantially constant force balancing mechanism which may allow for easy adjustment of the sliding riser system 1 in both directions. The substantially pressure balanced design may aid in preventing the sliding riser 15 from self-adjusting.

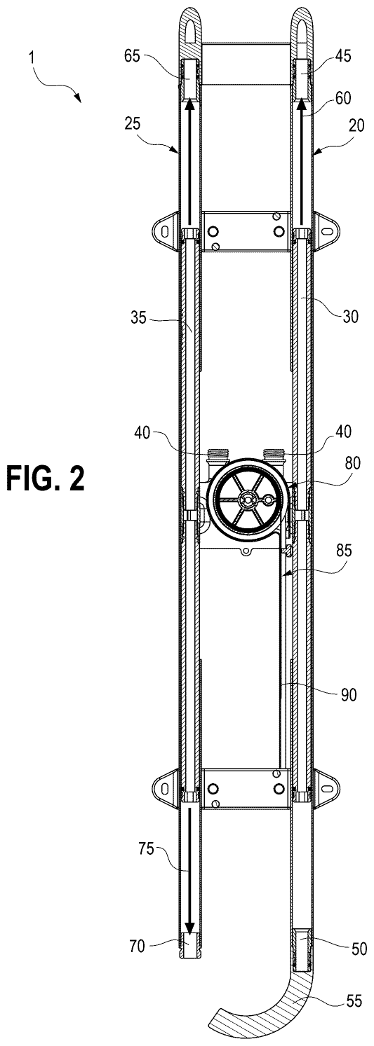

Turning now to FIG. 2, the sliding riser system 1 may include a first and second moving riser bar 20, 25, each which may house a fixed inlet waterway 30, 35, respectively. The first and second moving riser bars 20, 25 may be attached or connected in any suitable manner, such that movement of one causes movement of the other. Water may flow into the sliding riser system 1 via any suitable manner. As illustrated, the sliding riser system 1 may include two input line connections 40 which may be connected to any suitable water input. Although two are illustrated, there may be any number of input line connections 40, which may be positioned or designed in any suitable manner. Water may flow into the sliding riser system 1 via the input line connections 40 and may flow into and through the fixed inlet waterways 30, 35 positioned within the moving riser bars 20, 25, respectively. The fixed inlet waterways 30, 35 may be fixed in one position such that, even when the moving riser bars 20, 25 are adjusted, the fixed inlet waterways 30, 35 may not adjust. As such, the moving riser bars 20, 25 may be independently formed from the fixed inlet waterways 30, 35, to aid in ensuring that the moving riser bars 20, 25 may adjust without adjusting the fixed inlet waterways 30, 35.

The first moving riser bar 20 may be attached at a first end 45 to a showerhead (not illustrated in FIG. 2, but similar to the showerhead 5 of FIG. 1, for example), and when water is turned on, water may flow out of the first fixed inlet waterway 30 into the first moving riser bar 20 via the showerhead. A second end 50 of the first moving riser bar 20 may include or be connected to a handle 55, which a user may use to adjust a height of the showerhead. The second end 50 of the first moving riser bar 20 may be blocked off such that water may not flow out of the second end 50 or the handle 55. Water may flow out of the first moving riser bar 20 in the direction as illustrated by arrow 60. The second moving riser bar 25 may be blocked off at a first end 65 such that water may not flow out of the second fixed inlet waterway 35 or second moving riser bar 25 via the first end 65. The second moving riser bar 25 may be attached at a second end 70 to a hose which may be connected to a handheld showerhead (not illustrated in FIG. 2, but similar to the showerhead 5 of FIG. 1, for example). Water may flow out of the second fixed inlet waterway 35 into the second moving riser bar 25 in the direction as illustrated by arrow 75.

The first and second moving riser bars 20, 25 may be flooded at both ends such that water fills, or substantially fills, the first and second moving riser bars 20, 25 when the water is turned on. The water volume within the first and second moving riser bars 20, 25 may remain substantially constant even when the sliding riser system 1 is adjusted. Because of the fixed volume even when the sliding riser system 1 is adjusted, the sliding riser system 1 may be substantially pressure balanced which may aid in preventing movement of the sliding riser system 1 typically caused by water pressure.

The sliding riser system 1 may include a balance spring mechanism 80, which may be fixed to a surface, including a wall. The balance spring mechanism 80 may be fixed in any suitable manner and may be fixed in a similar manner as the fixed inlet waterways 30, 35. The balance spring mechanism 80 may include a balance spring 85, which may include a free end 90 connected to at least one of the first and second moving riser bars 20, 25. As illustrated, the free end 90 of the balance spring 85 is attached to the first moving riser bar 20; however, it should be understood that the balance spring 85 may also or instead be attached to the second moving riser bar 25. The balance spring 85 may provide a substantially constant force to the first moving riser bar 20. The substantially constant force may be substantially equal to the mass of the first moving riser bar 20 (including the mass of the water within the first moving riser bar 20). The balance spring 85 may aid in preventing movement of the first moving riser bar 20 (and so too the second moving riser bar 25) due to gravity. The balance spring 85 may aid in reducing the amount of force required in order to adjust the sliding riser system 1.

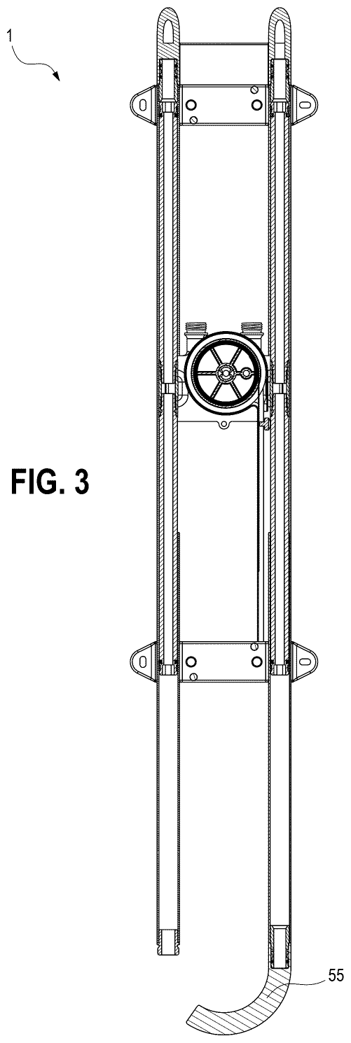

A user may use the handle 55 to adjust the height of the sliding riser system 1 to adjust the height of the showerhead. As illustrated in FIG. 2, the sliding riser system 1 is in a first position, and when the handle 55 is pushed or pulled by a user, the sliding riser system 1 may translate in a vertical direction to adjust the height of the sliding riser system 1. As one example, the sliding riser system 1 may be adjusted via the handle 55 from the first position, as illustrated in FIG. 2, to a second position, as illustrated in FIG. 3. The second position may be lower than the first position, and as one example, may be particularly useful for a shorter person using the shower.

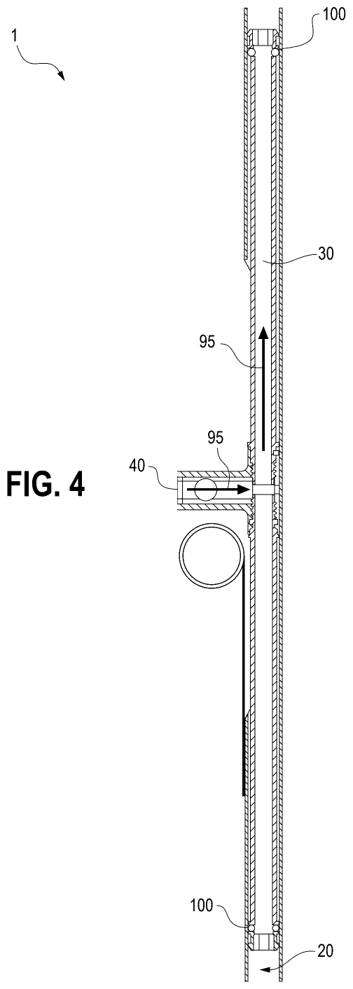

Turning to FIG. 4, the sliding riser system 1 may be attached to a showerhead (not illustrated in FIG. 4, but similar to the showerhead 5 of FIG. 1, for example), and water may flow into the sliding riser system 1 via one of the input line connections 40. Water may flow to the showerhead in the direction as illustrated by arrows 95. As discussed above, the fixed inlet waterways 30, 35 (illustrated in FIG. 4 as first fixed inlet waterway 30) may be fixed such that, even when the moving riser bars 20, 25 (illustrated in FIG. 4 as first moving riser bar 20) are moved, the fixed inlet waterways 30, 35 may not move. The fixed inlet waterways 30, 35 may include seals 100 at each end, which may be low friction seals, to aid in preventing movement or leakage from the fixed inlet waterways 30, 35. Even when the moving riser bars 20, 25 are adjusted, the seals 100 may aid in preventing a change of the volume of water within the sliding riser system 1, which may aid in maintaining a substantially constant pressure within the sliding riser system 1 which may prevent self-adjustment of the sliding riser system 1.

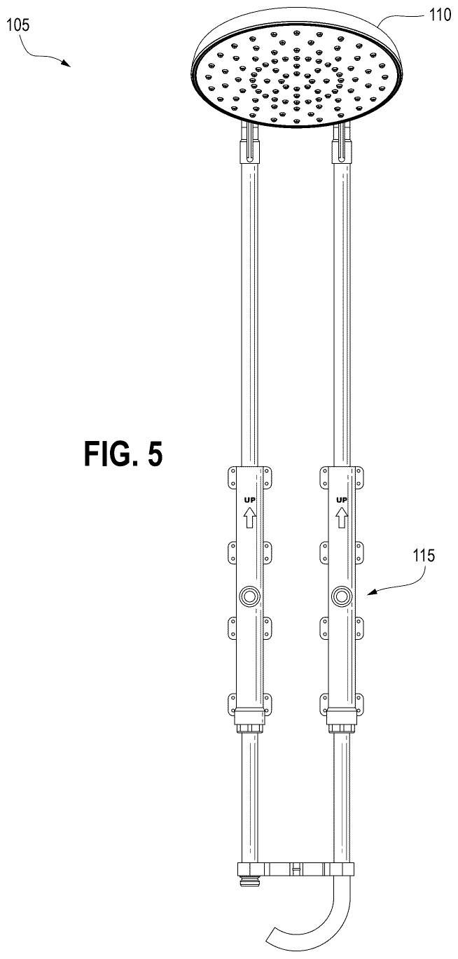

Turning now to FIG. 5, a sliding riser system 105 may include a showerhead 110 (the showerhead 110 may be any desirable or suitable showerhead) connected to a sliding riser 115. The sliding riser 115 may be used to adjust the showerhead 110 to a different height, which may accommodate different heights of users. Further, the sliding riser 115 may be used to adjust the showerhead 110 even when fluid (e.g., water) is flowing through the sliding riser system 105 and out of the showerhead 110. The sliding riser system 105 may adjust in height in large adjustment ranges and may be substantially pressure balanced such that the sliding riser system 105 may be adjusted in height and maintain a desirable pressure when adjusted. The sliding riser system 105 may be adjusted even when water is flowing through the showerhead 110 and the showerhead 110 is in use. Further, the sliding riser system 105 may incorporate a substantially constant force balancing mechanism which may allow for easy adjustment of the sliding riser system 105 in both directions. The substantially pressure balanced design may aid in preventing the sliding riser 115 from self-adjusting.

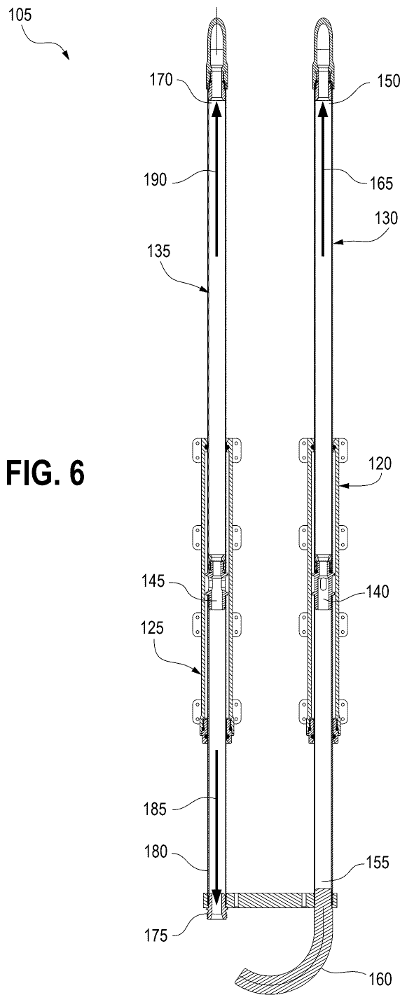

As illustrated in FIG. 6, the sliding riser system 105 may include a first and second fixed inlet waterway 120, 125, each which may house at least a portion of a first and second moving riser bar 130, 135, respectively. The first and second moving riser bars 130, 135 may be attached or connected in any suitable manner, such that movement of one causes movement of the other. The fixed inlet waterways 120, 125 may be fixed to a surface (e.g., a wall) and may not adjust despite movement of the moving riser bars 130, 135. Water may flow into the fixed inlet waterways 120, 125 via any suitable means, including via a water inlet connection (which may be connected to any suitable fluid output).

As stated, a portion of the moving riser bars 130, 135 may be positioned within the respective fixed inlet waterways 120, 125, such that the moving riser bars 130, 135 translate vertically within the fixed inlet waterways 120, 125. The moving riser bars 130, 135 may include a fluid inlet 140, 145, respectively, whereby water may enter the moving riser bars 130, 135 via the fixed inlet waterways 120, 125.

The first moving riser bar 130 may be attached at a first end 150 to a showerhead (not illustrated in FIG. 6, but similar to the showerhead 5 of FIG. 1 or the showerhead 110 of FIG. 5, for example), and when water is turned on, water may flow out of the first moving riser bar 130 via the showerhead. A second end 155 of the first moving riser bar 130 may include or be connected to a handle 160, which a user may use to adjust a height of the showerhead. The second end 155 of the first moving riser bar 130 may be blocked off such that water may not flow out of the second end 155 or the handle 160. Water may flow out of the first moving riser bar 130 in the direction as illustrated by arrow 165. The second moving riser bar 135 may be attached at a first end 170 to the showerhead. The second moving riser bar 135 may include a coupling mechanism 175 at a second end 180 which may be used to attach to a hose which may be connected to a handheld showerhead (not illustrated in FIG. 6, but similar to the showerhead 5 of FIG. 1 or the showerhead 110 of FIG. 5, for example). When connected to a hose, water may flow out of the second moving riser bar 135 in the direction as illustrated by arrow 185 toward the hose and by arrow 190 toward the showerhead. When not connected to a hose, the second end 180 may be blocked off such that water may not flow out of the second moving riser bar 135 via the second end 180.

The first and second moving riser bars 130, 135 may be flooded at both ends such that water fills, or substantially fills, the first and second moving riser bars 130, 135 when the water is turned on. The water volume within the first and second moving riser bars 130, 135 may remain substantially constant even when the sliding riser system 105 is adjusted. Because of the fixed volume even when the sliding riser system 105 is adjusted, the sliding riser system 105 may be substantially pressure balanced which may aid in preventing movement of the sliding riser system 105 typically caused by water pressure.

The sliding riser system 105 may include a balance spring mechanism (not illustrated in FIG. 6, but similar to the showerhead 5 of FIG. 1 or the showerhead 110 of FIG. 5, for example), which may be fixed to a surface, including a wall. The balance spring mechanism may operate, be affixed in, and provide similar functions as discussed with reference to the balance spring mechanism 80 of FIGS. 2-4.

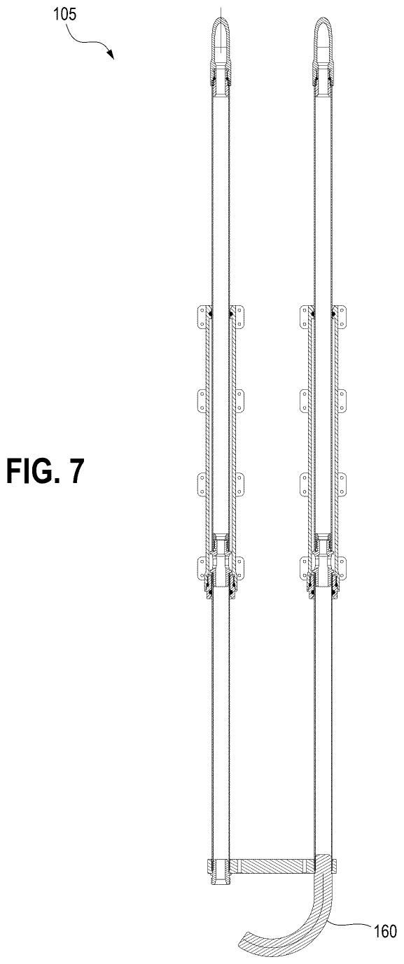

The handle 160 may adjust the height of the sliding riser system 105 to further adjust the height of the showerhead. As illustrated in FIG. 6, the sliding riser system 105 is in a first position, and when the handle 160 is pushed or pulled by a user, the sliding riser system 105 may translate in a vertical direction to adjust the height of the sliding riser system 105. As one example, the sliding riser system 105 may be adjusted via the handle 160 from the first position, as illustrated in FIG. 6, to a second position, as illustrated in FIG. 7. The second position may be lower than the first position, and as one example, may be particularly useful for a shorter person using the shower.

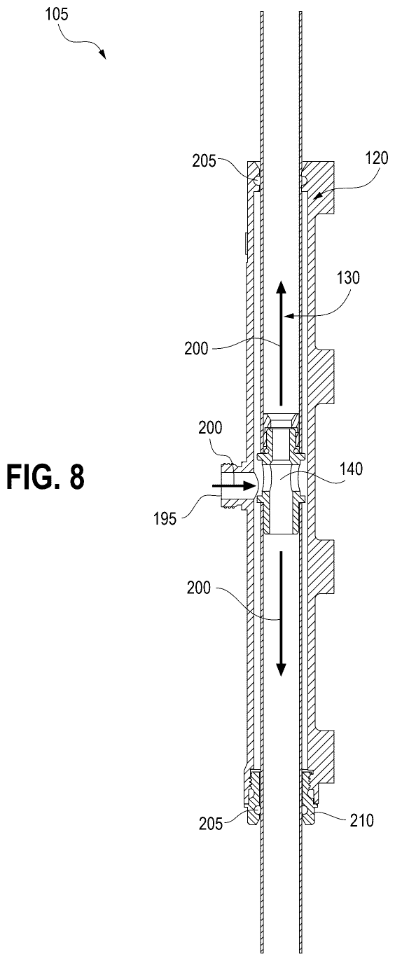

Turning to FIG. 8, the sliding riser system 105 may be attached to a showerhead (not illustrated in FIG. 8, but similar to the showerhead 5 of FIG. 1 or the showerhead 110 of FIG. 5, for example), and water may flow into the sliding riser system 105 via an inlet 195 positioned on the fixed inlet waterways 120, 125 (illustrated in FIG. 8 as first fixed inlet waterway 120). Water may then flow into the moving riser bars 130, 135 (illustrated in FIG. 8 as first moving riser bar 130) via the fluid inlet 140. Water may flow in the moving riser bar 130 in the direction as illustrated by arrows 200. The fixed inlet waterways 120, 125 may be fixed such that, even when the moving riser bars 130, 135 are moved, the fixed inlet waterways 120, 125 may not move. The fixed inlet waterways 120, 125 may include seals 205 (which may be low friction seals) at each end and a gland nut 210 at one end to aid in preventing movement or leakage from the fixed inlet waterways 120, 125. Even when the moving riser bars 130, 135 are adjusted, the seals 205 may aid in preventing a change of the volume of water within the sliding riser system 105, which may aid in maintaining a substantially constant pressure within the sliding riser system 105 which may prevent self-adjustment of the sliding riser system 105.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A sliding riser system comprising:
at least one fixed inlet waterway connected to a fluid line for providing a fluid to the sliding riser system;
at least one moving riser bar attached at a first end to a showerhead for providing the fluid to a user, wherein the at least one moving riser bar is adjustable to adjust a height of the showerhead; and
a balance spring mechanism comprising a balance spring attached at a free end to the at least one moving riser bar, wherein the balance spring provides a substantially constant force to the at least one moving riser bar;
wherein either:
a portion of the at least one moving riser bar is housed within the at least one fixed inlet waterway; or
a portion of the at least one fixed inlet waterway is housed within the at least one moving riser bar.

2. The sliding riser system of claim 1, wherein the substantially constant force is substantially equal to a mass of components within the at least one moving riser bar plus a mass of the fluid flowing into the at least one moving riser bar via the at least one fixed inlet waterway.

3. The sliding riser system of claim 1, wherein, when the at least one moving riser bar is adjusted, the at least one fixed inlet waterway remains substantially fixed.

4. The sliding riser system of claim 1, wherein, when the at least one moving riser bar is adjusted, a pressure of the fluid provided via the showerhead is maintained substantially constant.

5. The sliding riser system of claim 1, wherein the at least one moving riser bar is a first moving riser bar, and wherein the sliding riser system further comprises a second moving riser bar.

6. The sliding riser system of claim 5, wherein adjustment of the first moving riser bar causes adjustment of the second moving riser bar, and wherein adjustment of the second moving riser bar causes adjustment of the first moving riser bar.

7. The sliding riser system of claim 1, wherein a second end of the at least one moving riser bar includes a handle for adjusting the height of the showerhead.

8. The sliding riser system of claim 1, wherein, when the at least one moving riser bar is adjusted, a volume of the fluid within the at least one moving riser bar is maintained substantially constant.

9. A sliding riser system comprising:
at least one fixed inlet waterway connected to a fluid line for providing a fluid to the sliding riser system;
at least one moving riser bar attached at a first end to a showerhead for providing the fluid to a user, wherein the at least one moving riser bar is adjustable to adjust a height of the showerhead, and wherein, when the at least one moving riser bar is adjusted, the at least one fixed inlet waterway remains substantially fixed; and
a balance spring mechanism comprising a balance spring attached at a free end to the at least one moving riser bar, wherein the balance spring provides a substantially constant force to the at least one moving riser bar.

10. The sliding riser system of claim 9, wherein a portion of the at least one moving riser bar is housed within the at least one fixed inlet waterway.

11. The sliding riser system of claim 9, wherein a portion of the at least one fixed inlet waterway is housed within the at least one moving riser bar.

12. The sliding riser system of claim 9, wherein the substantially constant force is substantially equal to a mass of components within the at least one moving riser bar plus a mass of the fluid flowing into the at least one moving riser bar via the at least one fixed inlet waterway.

13. The sliding riser system of claim 9, wherein, when the at least one moving riser bar is adjusted, a pressure of the fluid provided via the showerhead is maintained substantially constant.

14. The sliding riser system of claim 9, wherein a second end of the at least one moving riser bar includes a handle for adjusting the height of the showerhead.

15. The sliding riser system of claim 9, wherein, when the at least one moving riser bar is in a first position, the showerhead is positioned at a first height, and wherein, when the at least one moving riser bar is in a second position, the showerhead is positioned at a second height.

16. The sliding riser system of claim 15, wherein the first height is greater than the second height.

17. A sliding riser system comprising:
a first fixed inlet waterway connected to a first fluid line for providing a first fluid to the sliding riser system;
a second fixed inlet waterway connected to a second fluid line for providing a second fluid to the sliding riser system;
a first moving riser bar attached at a first end to a showerhead for providing the first fluid to a user; and
a second moving riser bar attached at a second end to a handheld showerhead for providing the second fluid to the user;
wherein either:
a portion of the first moving riser bar is housed within the first fixed inlet waterway, and a portion of the second moving riser bar is housed within the second fixed inlet waterway; or
a portion of the first fixed inlet waterway is housed within the first moving riser bar, and a portion of the second fixed inlet waterway is housed within the second moving riser bar.

18. The sliding riser system of claim 17, further comprising at least one balance spring mechanism comprising a balance spring attached at a free end to at least one of the first moving riser bar and the second moving riser bar, wherein the balance spring provides a substantially constant force to at least one of the first moving riser bar and the second moving riser bar.

19. The sliding riser system of claim 17, wherein adjustment of the first moving riser bar causes adjustment of the second moving riser bar, and wherein adjustment of the second moving riser bar causes adjustment of the first moving riser bar.

20. The sliding riser system of claim 17, wherein, when the first moving riser bar is adjusted, the first fixed inlet waterway remains substantially fixed, and wherein, when the second moving riser bar is adjusted, the second fixed inlet waterway remains substantially fixed.
